(19) United States
(12) Patent Application Publication
(10) Pub. No.: US 2014/0219489 A1
(43) Pub. Date: Aug. 7, 2014

(54) WIRELESS SPEAKER WITH PARABOLIC REFLECTORS

(71) Applicant: Matthew WALDMAN, New York, NY (US)

(72) Inventor: Matthew WALDMAN, New York, NY (US)

(21) Appl. No.: 14/172,836

(22) Filed: Feb. 4, 2014

Related U.S. Application Data
(60) Provisional application No. 61/760,222, filed on Feb. 4, 2013.

(51) Int. Cl. H04R 3/00; H04R 1/34

(52) U.S. Cl. CPC H04R 3/00; H04R 1/34
USPC 381/334

(57) ABSTRACT

Described herein is an acoustic device including a speaker device adapted to wirelessly connect to, and relay audio signals from, an audio source. An external acoustic reflector is adapted to receive the speaker device inside or on the external acoustic reflector. The external acoustic reflector amplifies a sound generated by the speaker device.

### CROSS-REFERENCE TO RELATED APPLICATIONS

This application claims priority to U.S. Provisional Patent Application Ser. No. 61/760,222, filed Feb. 4, 2013, which is hereby incorporated by reference herein in its entirety.

### FIELD OF THE INVENTION

The invention relates generally to acoustic systems, and more particularly to a portable, wireless speaker with parabolic reflectors.

### BACKGROUND OF THE INVENTION

Generally, audio speakers of different sizes are utilized for producing high-quality sounds of different frequencies. Portable speakers that can produce high-quality sounds across the audio spectrum are required.

### SUMMARY OF THE INVENTION

According to an aspect of the invention, an acoustic device includes a speaker device adapted to wirelessly connect to, and relay audio signals from, an audio source. An external acoustic reflector is adapted to receive the speaker device inside or on the external acoustic reflector. The external acoustic reflector amplifies a sound generated by the speaker device.

According to another aspect of the invention, a method of making an acoustic device includes disposing a speaker device inside (or on) an acoustic reflector. The speaker device may be adapted to wirelessly connect to, and relay audio signals from, an audio source. The speaker device may be disposed such that the acoustic reflector amplifies a sound generated by the speaker device.

According to yet another aspect of the invention, a method of amplifying sound includes disposing a speaker device in or on an external acoustic reflector. The speaker device is adapted to wirelessly connect to, and relay audio signals from, an audio source. The external acoustic reflector is adapted to receive the speaker device inside or on to the external acoustic reflector

This disclosure is not limited to the particular systems, devices, or methods described herein. Further, as used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

### BRIEF DESCRIPTION OF THE DRAWING FIGURES

In the disclosure, reference is made to the accompanying drawing figures, which form a part hereof. In the drawing figures, similar symbols typically identify similar components, unless context dictates otherwise. The illustrative implementations described in the detailed description, drawings, and claims are not meant to be limiting. Other implementations may be used, and other changes may be made, without departing from the spirit or scope of the subject matter presented herein. It will be readily understood that the aspects of the disclosure, as generally described herein, and illustrated in the drawing figures, can be arranged, substituted, combined, separated, and designed in a wide variety of different configurations, all of which are explicitly contemplated herein.

FIG. 1 depicts a perspective view of a wireless speaker device, according to an aspect of the invention.

FIG. 2 depicts a side view of the wireless speaker device, according to an aspect of the invention.

FIG. 3 depicts a side view of the wireless speaker device showing controls, according to an aspect of the invention.

FIG. 4 depicts a cross-section view of the wireless speaker device, according to an aspect of the invention.

FIG. 5 depicts a perspective view of an external acoustic reflector with the wireless speaker device, according to an aspect of the invention.

FIG. 6 depicts a perspective view of the external acoustic reflector with the wireless speaker device resting at an angle on a surface, according to an aspect of the invention.

FIG. 7 depicts a close-up view of the external acoustic reflector, according to an aspect of the invention.

FIG. 8 depicts a back perspective view of the external acoustic reflector, according to an aspect of the invention.

FIG. 9 depicts a perspective view of the external acoustic reflector mounted on a wall, with the wireless speaker device, according to an aspect of the invention.

FIG. 10 depicts a cross-section view of the external acoustic reflector with the wireless speaker device, according to an aspect of the invention.

FIG. 11 depicts a close-up cross-section view of the external acoustic reflector with the wireless speaker device, according to an aspect of the invention.

FIG. 12 depicts a back view of the external acoustic reflector, according to an aspect of the invention.

FIG. 13 depicts a back view of the external acoustic reflector in a configuration alternate to one depicted in FIG. 12, according to an aspect of the invention.

### DETAILED DESCRIPTION OF THE INVENTION

Described herein are acoustic devices and method of making the acoustic devices. In an implementation, an acoustic device described herein includes a speaker device adapted to wirelessly connect to, and relay audio signals from an audio source, and an external acoustic reflector adapted to receive the speaker device inside or on to the external acoustic reflector. The external acoustic reflector amplifies a sound generated by the speaker device.

In an implementation, the speaker device may include one or more transceivers configured to receive wireless signals such as, for example, WiFi, Bluetooth, Radio, Cellular, Satellite, WiGig, WiDi, ZigBee, and the like. Such transceivers enable the speaker device to connect with one or more audio sources. The audio sources may include, for example, a music device (e.g., Walkman, iPod, etc.), a television, a desktop or mobile computer, a game console, an alarm system, and the like.

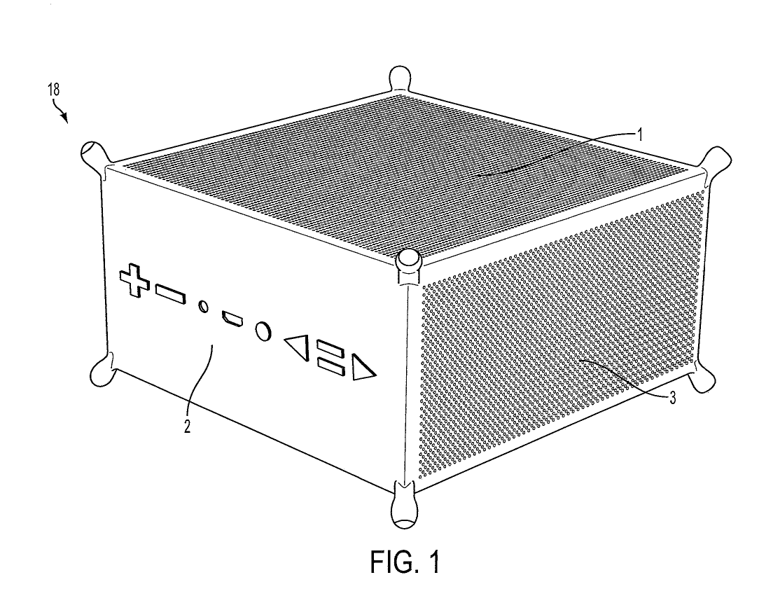

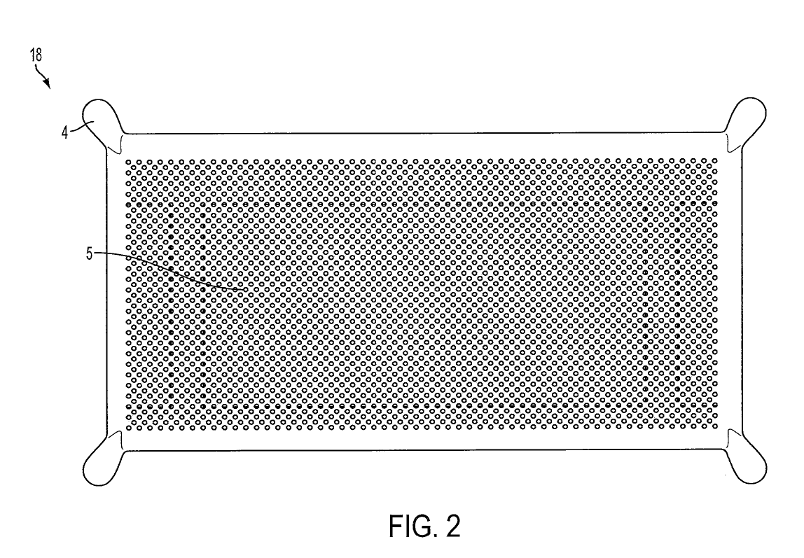

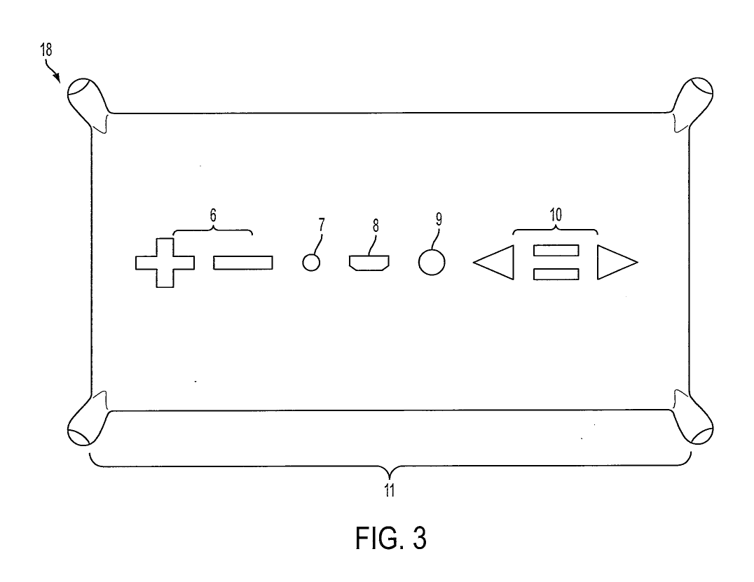

FIG. 1 depicts a perspective view of a wireless speaker device and FIGS. 2 and 3 each depict a side view of the wireless speaker device, according to an implementation. Wireless speaker device 18 includes a mesh enclosure depicted by features 1, 3 and 5, a control panel depicted 2 and feet 4. Control panel 2 may include volume control 6, power control 9, and track or channel control 10. Wireless speaker device may additionally include, in some implementations, an audio output port 7, a charging port 8 and/or connectors 11.

In various implementations, the mesh enclosure may be made from a metallic material, a cloth, or a polymer material. In some implementations, control panel 2 may include buttons, or touch-sensitive regions. In various implementations, audio output port 7 may include a 3.5 mm audio jack, a 2.5 mm audio jack, an RCA port, and/or any other output port. Likewise, in different implementations, charging port 8 may include a mini USB port, a micro USB port, a lightning port, or any other standard or proprietary port. In some embodiments, connectors 11 may include inductive charge connectors or electrical contacts.

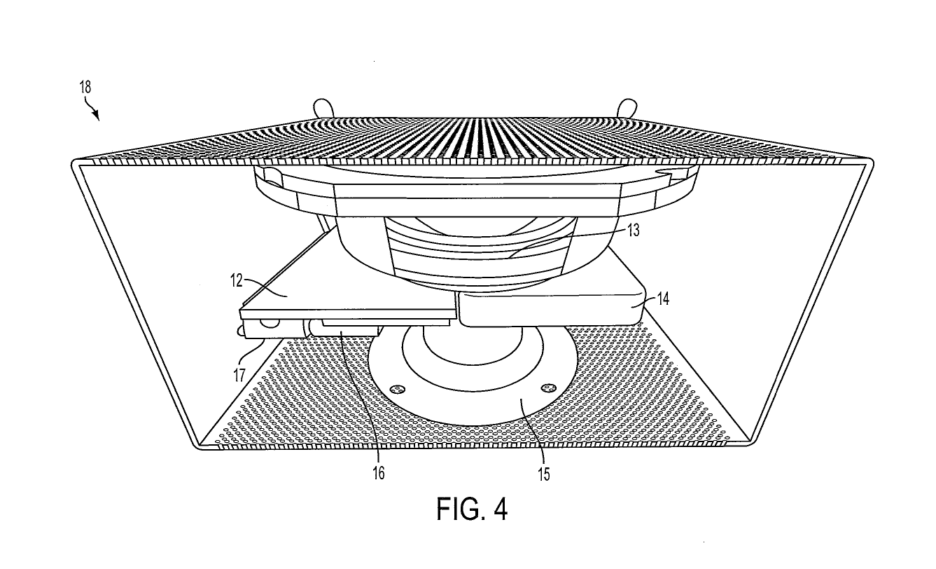

FIG. 4 depicts a cross-section view of wireless speaker device 18 according to an implementation. Enclosed in the mesh enclosure are motherboard 12, connected to midrange acoustic speaker 13, rechargeable battery 14, high range acoustic speaker 15, Bluetooth radio 16 and WiFi radio 17.

Motherboard 12 includes on-board electronics to enable wireless speaker device 18 to, for example, decode the various signals received via Bluetooth radio 16 or WiFi radio 17 and convert them into audio signals to be relayed to speakers 13 and 15. Additionally, motherboard 12 may include electronics for controlling wireless speaker device 18, for example, to provide volume control, or toggle tracks and/or channels, and so forth. Bluetooth radio 16 and/or WiFi radio 17 allow the wireless speaker to connect with various audio sources. In various implementations, additional or alternate radios or transceivers may be included in wireless speaker device 18. It will be understood by one of ordinary skill in the art that motherboard 12 may include additional electronics to decode signals that may be received from the additional radios and/or transceivers.

While two acoustic speakers are illustrated in FIG. 4, it will be understood that wireless speaker device 18 may, in some implementations, include other numbers of speakers each dedicated to produce sounds in a particular frequency band. For example, as illustrated in FIG. 4, wireless speaker device 18 may include high-range speaker 15 (tweeter) for high-frequency audio, and mid-range acoustic speaker 13 for mid-band frequency audio. Additionally, a third speaker for low frequency audio (e.g., a sub-woofer), (not illustrated) may be included. Other speakers for other frequency bands may additionally or alternatively be included. This allows wireless speaker device 18 to produce high-quality sounds within each frequency band. In various implementations, any number of speakers may be included in the speaker device to improve fidelity of sound.

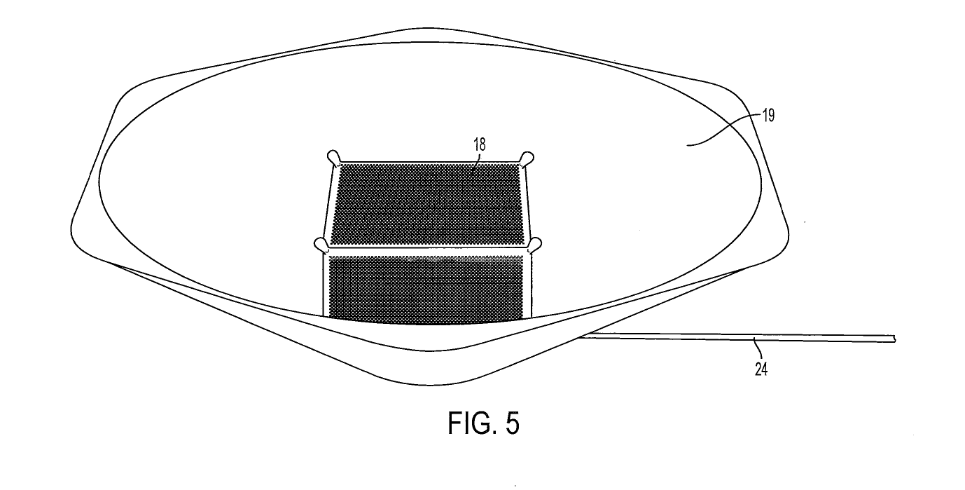

FIG. 5 depicts a perspective view of an external acoustic reflector 19 with the wireless speaker device 18, according to an implementation. In an implementation, wireless speaker device 18 is disposed along (i.e., within a concave portion of) external acoustic reflector 19 which may be formed to have a parabolic shape such that the speaker device rests at the focus of the paraboloid. This causes the sound generated by wireless speaker device 19 to be amplified by the external acoustic reflector 19 and directed along the axis of the parabola. In various implementations, external acoustic reflector 19 may have any shape including, for example, spheroid, paraboloid, ellipsoid, and the like.

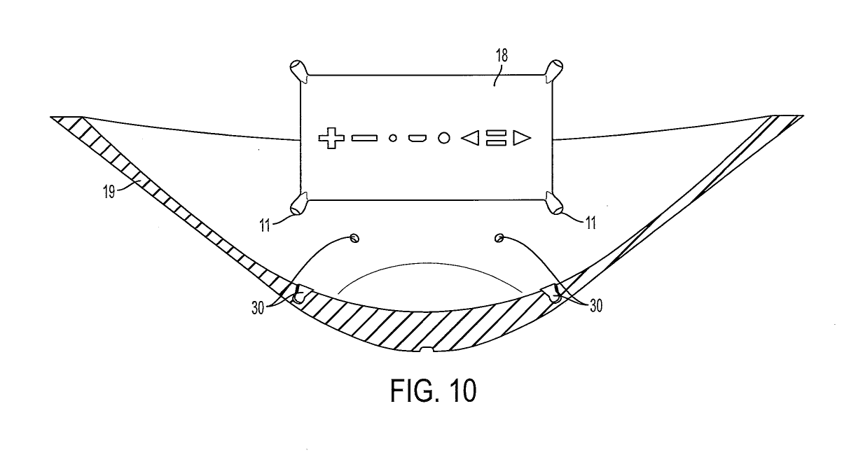

FIG. 10 depicts a cross-section view of the external acoustic reflector with the wireless speaker device, according to an implementation. External acoustic reflector 19 may, in some implementations, have recessed structures 30 on its inner (concave) surface to secure wireless speaker device 18 in place once it is disposed inside external acoustic reflector 19.

In an implementation, recessed structures 30 may include inductive charge connectors 11 to allow charging of rechargeable battery 14 (illustrated in FIG. 4) of wireless speaker 18 via inductive charge connectors 11. External acoustic reflector 19, in such implementations, may be adapted to receive power via a power cord 24 (illustrated in FIG. 5). External acoustic reflector 19 in such implementations will have electronic circuits for appropriately converting electric power received via power cord 24 to allow charging of rechargeable battery 14 using inductive or other type of charging.

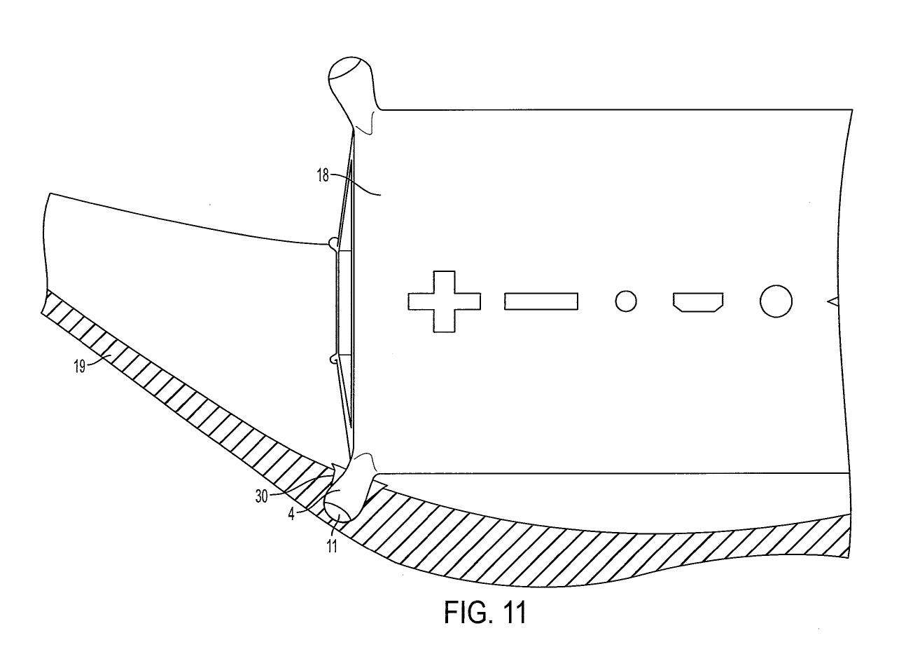

FIG. 11 depicts a close-up cross-section view of external acoustic reflector 19 with wireless speaker device 18, according to an implementation. In an implementation, recessed structures 30 and feet 4 may include electrical contacts 11. Electrical contacts 11 on feet 4 in such an implementation may be connected to rechargeable battery 14 (illustrated in FIG. 4). The recessed structures 30 are adapted such that when wireless speaker device 18 is placed along external acoustic reflector 19, an electrical connection is made between rechargeable battery 14 and power cord 24 (illustrated in FIG. 5). Thus, in operation, when wireless speaker device 18 is placed inside external acoustic reflector 19, any power received by power cord 24 is relayed to rechargeable battery 14.

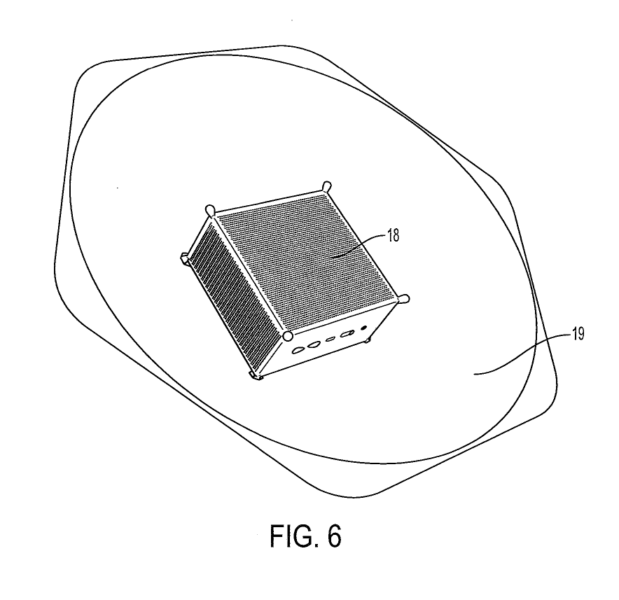

The back surface of external acoustic reflector 19 may or may not conform to its concave inner surface. FIG. 6 depicts a perspective view of external acoustic reflector 19 with wireless speaker device 18 resting at an angle on a surface, according to an implementation. In an implementation, the back surface may be adapted such that external acoustic reflector 19 may rest on a flat surface. In such an implementation, feet 4 of wireless speaker device 18 are secured by recessed structures 30, thereby enabling wireless speaker device 18 to retain its position within external acoustic reflector 19.

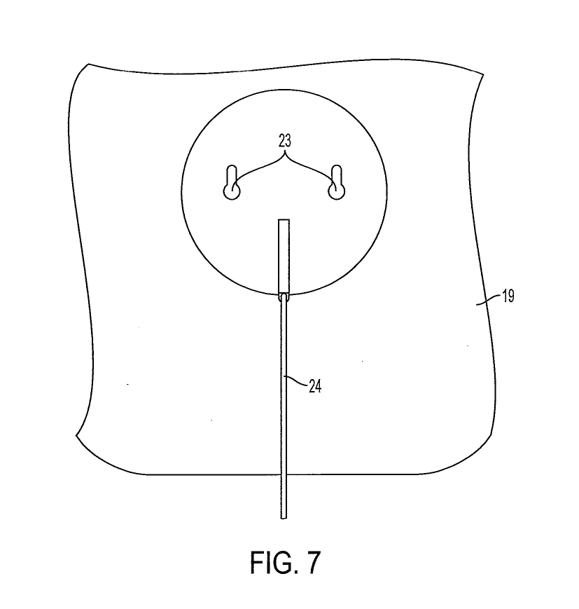

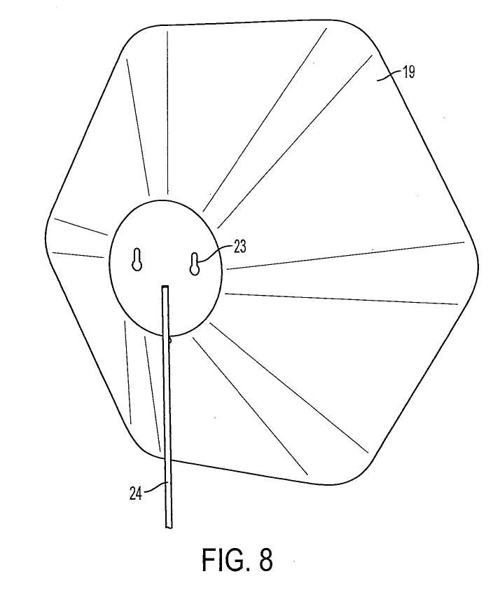

FIGS. 7 and 8 depict a back view of the external acoustic reflector, according to an implementation. In such implementations, external acoustic reflector 19 may further include one or more holes 23 or other mounting structures on its back surface to allow mounting external acoustic reflector 19 on a wall or any other surface. In other implementations, external acoustic reflector 19 may be mounted on a vertical surface using, for example, fasteners, or adhesives.

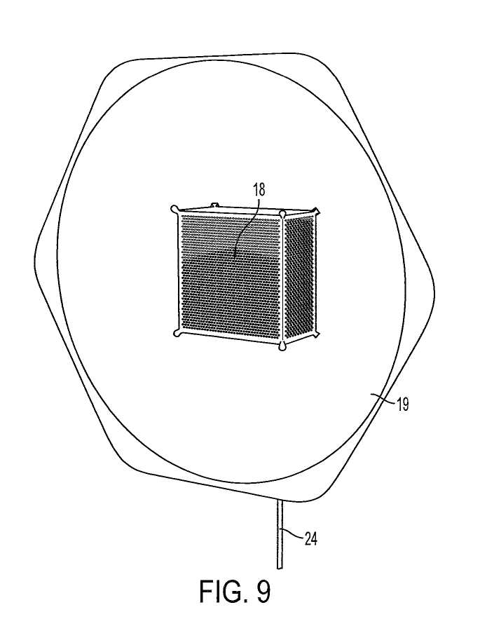

FIG. 9 depicts wireless speaker device 18 held in position inside the concave portion of external acoustic reflector 19 that is mounted in a vertical position.

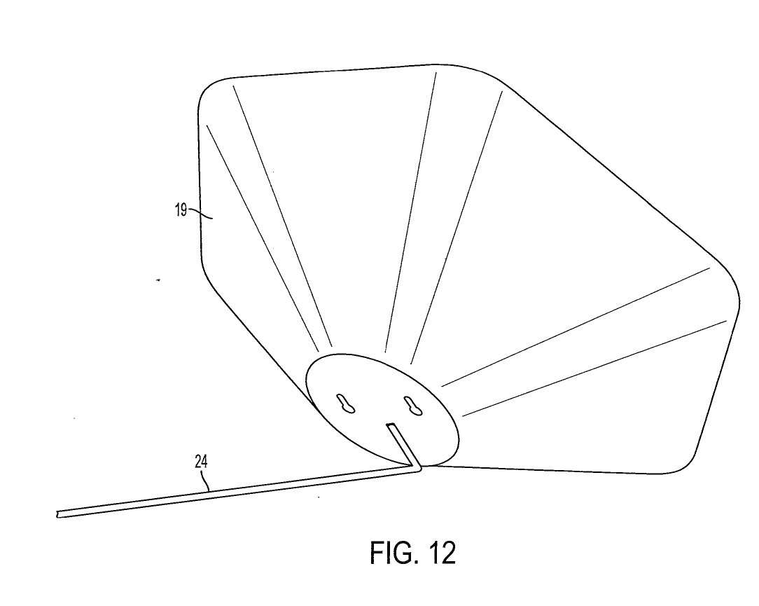

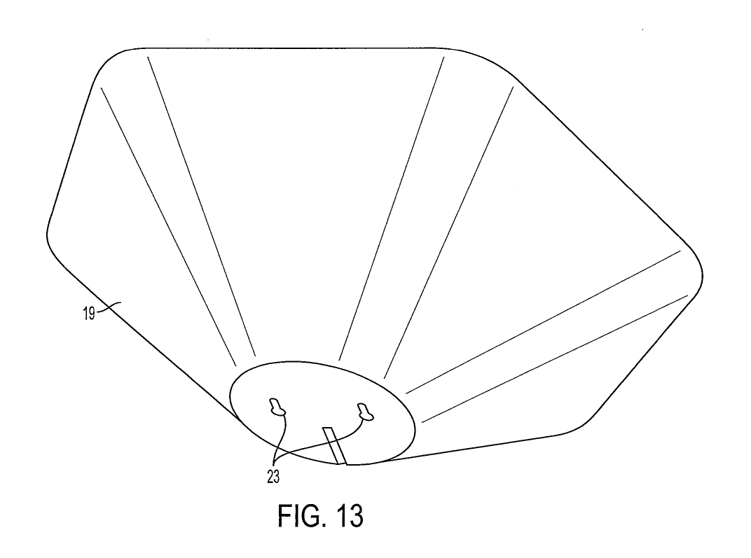

In some implementations, external acoustic reflector 19 may be adapted to be foldable. For example, it may be formed using a plurality of interlocking parts (not illustrated) that may be assembled to form the acoustic reflector. Such assembly allows a user to disassemble the external acoustic reflector and more easily carry it with them. Thus, in operation, a user may assemble the reflector, attach the wireless speaker device to the external acoustic reflector and associate the wireless speaker device with an audio source of their choice. Using such an external acoustic reflector allows the user to amplify the sound generated by the wireless speaker device. Such an acoustic may be powered using a power cord (as illustrated in FIG. 12). Alternatively, the rechargeable battery included with the wireless speaker allows such an acoustic device to be completely untethered as illustrated in FIG. 13.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. An acoustic device comprising:
a speaker device adapted to wirelessly connect to, and receive an audio signal, from an audio source, and generate a sound based on the audio signal; and
an external acoustic reflector adapted to receive the speaker device along the external acoustic reflector, wherein the external acoustic reflector amplifies the sound generated by the speaker device.

2. The acoustic device of claim 1, wherein the external acoustic reflector includes a parabolic curve such that the external acoustic reflector is adapted to receive the speaker device at a focus of the parabolic curve.

3. The acoustic device of claim 1, wherein the external acoustic reflector is foldable.

4. The acoustic device of claim 1, wherein the speaker device comprises a plurality of speakers, each adapted to produce sounds in a corresponding band of audio frequency.

5. The acoustic device of claim 1, wherein the speaker device comprises one or more transceivers configured to receive wireless signals.

6. The acoustic device of claim 1, wherein the speaker device is configured to receive one or more of WiFi, Bluetooth, Radio, Cellular, Satellite, WiGig, WiDi, and ZigBee signals.

7. The acoustic device of claim 1, wherein the speaker device and the external acoustic reflector each comprises one or more inductive charging connectors.

8. The acoustic device of claim 1, wherein the speaker device comprises one or more of power, volume, and track or channel controls.

9. The acoustic device of claim 1, wherein the speaker device comprises a rechargeable battery.

10. A method of making an acoustic device, the method comprising:
disposing a speaker in or on an acoustic reflector, the speaker being adapted to wirelessly connect to, and relay audio signal from an audio source, wherein speaker device is disposed such that the acoustic reflector amplifies a sound generated by the speaker device.

11. The method of claim 10, wherein the speaker device comprises a plurality of speakers, each adapted to produce sounds in a different band of audio frequencies.

12. The method of claim 10, wherein the speaker device comprises one or more transceivers configured to receive wireless signals.

13. The method of claim 10, wherein the speaker device and the external acoustic reflector each comprises one or more inductive charging connectors.

14. The method of claim 10, wherein the external acoustic reflector is foldable.

15. The method of claim 10, wherein the speaker device comprises a rechargeable battery.

16. The method of claim 10, wherein the speaker device comprises one or more of power, volume, and track or channel controls.

17. A method of amplifying sound, the method comprising:
wirelessly connecting to, and receiving an audio signal from, an audio source by a speaker device;
generating a sound based on the audio signal; and
amplifying by an external acoustic reflector, the sound generated by the speaker device, wherein the external acoustic device is adapted to receive the speaker device along the external acoustic reflector.

18. The method of claim 17, wherein the external acoustic reflector is foldable.

19. The method of claim 17, wherein the speaker device comprises one or more transceivers configured to receive wireless signals.

20. The method of claim 17, wherein the speaker device comprises a plurality of speakers, each adapted to produce sounds in a different band of audio frequencies.
